(19) United States
(12) Patent Application Publication
(10) Pub. No.: US 2007/0112610 A1
(43) Pub. Date: May 17, 2007

(54) SYSTEM AND METHOD FOR CLINICAL PROCESS DECISIONING

(75) Inventors: Christopher Donald Johnson, CLIFTON PARK, NY (US); Kunter Seref Akbay, NISKAYUNA, NY (US); Sung-Ho John Ahn, MATTHEWS, NC (US); Abha Moitra, SCOTIA, NY (US); Onur Ilkin Dulgeroglu, NISKAYUNA, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/559,045

(22) Filed: Nov. 13, 2006

Related U.S. Application Data
(60) Provisional application No. 60/737,219, filed on Nov. 15, 2005.

(51) Int. Cl. G06F 9/46

(52) U.S. Cl. 705/8

(57) ABSTRACT

A system and method for use in planning procedures subject to variation is provided comprising the following components: a duration estimator module configured to characterize average duration times and variations from average for a given procedure or activity; a block allocation planner module configured to schedule procedures or activities in accordance with characterized times from the duration estimator module; and a user interface module configured to permit a user to visualize variation, to visualize scheduling opportunities and constraints and to view information output for use in scheduling procedures and activities.

### CROSS REFERENCE TO RELATED APPLICATIONS

This application is related to Provisional Application U.S. Ser. No. 60/737,219, entitled “CLINICAL PROCESS DECISIONING”, filed Nov. 15, 2005, the contents of which are herein incorporated by reference and the benefit of priority to which is claimed under 35 U.S.C. 119(e).

### BACKGROUND

The invention relates generally to business scheduling systems, and more particularly to scheduling systems in the clinical setting, such as healthcare delivery institutions or hospitals.

Healthcare delivery institutions are business systems that can be designed and operated to achieve their stated missions robustly. As is the case with other business systems such as those designed to provide services and manufactured goods, there are benefits to reducing variation such that the stake-holders within these business systems can focus more fully on the value added core processes that achieve the stated mission and less on activity responding to needless variations such as delays, accelerations, backups, underutilized assets, unplanned overtime by staff and stock outs of material, equipment, people and space that were preventable and/or scheduled for. In this way the system can achieve its mission more reliably and be robust to exogenous forces outside of the process control.

Currently clinical process decisions have historically relied on the art of understanding symptoms and diagnosing causality much in alignment with the practice of the medical diagnosis arts. In an ever-evolving environment, judgment and experientially-developed mental models are utilized by the healthcare providers to utilize the information currently at hand to make decisions. Presented with similar data, the decision made from one maker to anther typically exhibits a large variation. Presented with partial information, which is the byproduct of being organized in functional departments, specialties, roles and by the nature of having partial and/or current information availability on hand—clinical process decisions vary widely and typically are locally focused for lack of a systems view upstream and downstream of the decision point.

Where information systems exist, they are informational in nature. Examples include scheduled rooms, people, materials and equipment. Recent advances in locating devices such as those utilizing radio-frequency identification (RFID) technology to report a location of a tagged asset. The current art is not predictive, probabilistic nor necessarily systemic.

There is therefore a need for a system and method for scheduling clinical activities and procedures that incorporate variation, staff and equipment preferences and information flow into the clinical delivery of healthcare.

### BRIEF DESCRIPTION

In accordance with a first aspect of the present invention, a system for use in planning procedures subject to variation is provided comprising the following components: a duration estimator module configured to characterize average duration times and variations from average duration times for a given procedure or activity; a block allocation planner module configured to schedule procedures or activities in accordance with characterized times from the duration estimator module; and a user interface module configured to permit a user to visualize variation, to visualize scheduling opportunities and constraints and to view information output for use in scheduling procedures and activities.

In accordance with a second aspect of the present invention, a method for planning procedures subject to variation is provided, the method comprises the following steps: deriving duration times for a given procedure; updating duration times for the given proceudre as variation is detected; and, using updated duration times for for forecasting and scheduling subsequent and/or concurrent procedures.

In accordance with a third aspect of the present invention, a system for use in planning clinical procedures is provided comprising the following components: a duration estimator module configured to characterize average duration times and variations from average duration times for a given clinical procedure or activity; a block allocation planner module configured to schedule procedures or activities in accordance with characterized times from the duration estimator module; and a user interface module configured to permit a user to visualize variation, to visualize scheduling opportunities and constraints and to view information output for use in scheduling clinical procedures and activities.

### DRAWINGS

These and other features, aspects and advantages of the present invention will become better understood when the following detailed description is read with reference to the accompanying drawings in which like characters represent like part throughout the drawings, wherein:

FIG. 1 is an exemplary illustration of the effects of variation on scheduling procedures;

FIG. 2 is a block diagram illustration of an embodiment of a duration estimator module to which embodiments of the present invention are applicable;

FIG. 3 is a block diagram illustration of an embodiment of a block allocation planner module to which embodiments of the present invention are applicable;

FIG. 4 is an illustration of a user display for an exemplary block allocation planner module;

FIG. 5 is an exemplary illustration of another user display applicable to embodiments of a user interface; and

FIG. 6 is a block diagram illustration of a system for use in planning clinical procedures in accordance with embodiments of the present invention.

### DETAILED DESCRIPTION

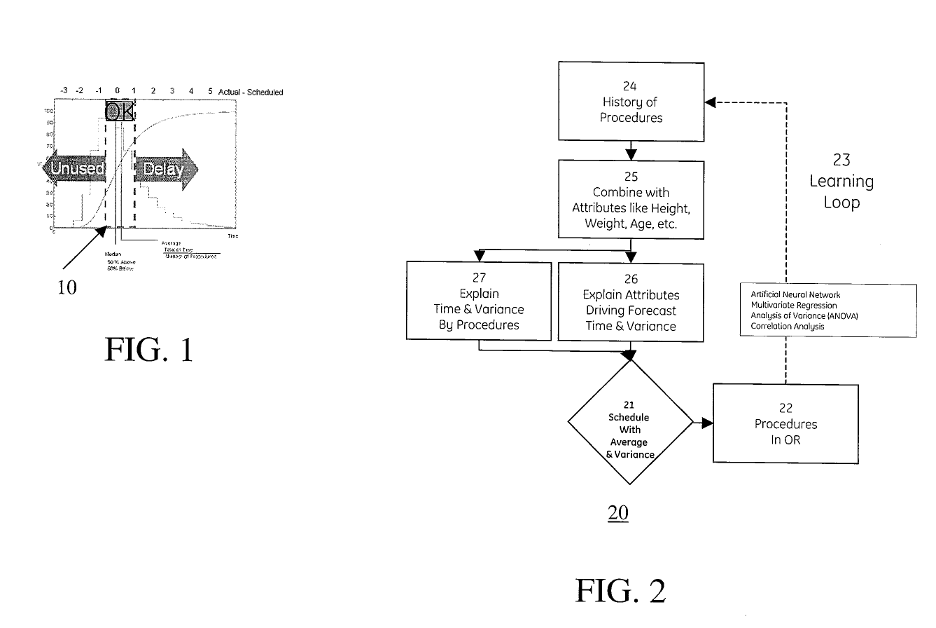

Referring to FIG. 1, a representative illustration of how variation impacts scheduling is shown. Typically the average time for a given procedure is subject to variation due to a variety of reasons. However, a healthcare institution or hospital schedules procedures based solely on average time duration per procedure. Therefore, if a number of procedures take longer than expected then the remainder of scheduled procedures may be delayed or rescheduled. Conversely, if procedures take less time than expected then there is a risk of unused availability. Both underutilization and scheduling delays are costly in time and resources.

The present invention reduces process variation and thereby enables staff to focus more on the clinical delivery of healthcare. This is achieved in four ways—(1) An overarching capability to reduce internal (endogenous) variation from interdependency variation that can be anticipated; (2) To incorporate variation into the process planning and control as far forward into the time line such that not only more accurate averages are used for scheduling, but also the probability ranges of time duration for various activities, availability, capability ranges for staff and equipment are incorporated and planned for; (3) An overarching capability to combine information flows as to the status of staff, patients, equipment and facilities with the scheduled plan such that anticipatory alerts are provided when schedule risk crosses a threshold as well as a diagnosis as to the cause of the likely or actual source of the deviation that is sufficient and actionable enough for intervention by the staff to resolve or revise a plan for it; and, (4) An overarching capability to understand and incorporate the effects of external (exogenous) variation resulting from unforcastable events such as, for example, surges, medical reason procedure delay, equipment failure and staff sickness.

In accordance with a first embodiment of the present invention, a system for use in planning procedures is provided comprising the following components: a duration estimator module configured to characterize average duration times and variations from average duration times for a given procedure or activity; a block allocation planner module configured to schedule procedures or activities in accordance with characterized times from the duration estimator module; and a user interface module configured to permit a user to visualize variation, to visualize scheduling opportunities and constraints and to view information output for use in scheduling procedures and activities. Each component or module will be described in greater detail below. In the embodiments described below, the given procedure is a clinical procedure or activity however it is to be appreciated that the methods and system can be extended to non-clinical procedures.

Duration Estimator: which may be thought of as a ‘better ruler to measure with’, measures variation so that procedure times are more accurate and so that schedule risk is reduced.

Block Allocation Planner: which may be thought of as a defragmenter is to a computer hard drive, it re-sorts the time slots and rooms to be available for the booking of surgeries. It factors in preferences and availabilities—and solves for the best departmental allocation of space and time and through the allocation, help achieve department policy objectives such as case mix, outcomes, safety and to provide incentive for desired behaviors.

The user interface module may comprise at least one of modules configured to permit a user to visualize variation, to visualize scheduling opportunities and constraints and provide output for use in scheduling procedures and activities, or combinations thereof.

In accordance with an exemplary embodiment, the user interface module is configured to indicate and display variation and will be referred to herein as “Day View”. Day View may be thought of as a radar for the clinical process, it brings schedule with other location and clinical information so that the staff can know when schedule deviations are occurring, what the cause is, a way to visualize process interdependencies and the ability to play out or simulate alternative process decisions.

In accordance with another exemplary embodiment, the user interface module is configured to aid in scheduling activities and procedures and is configured to visualize scheduling opportunities and constraints and will be referred to herein as “Day Planner”. Day Planner may be thought of as a manufacturing requisition planner, it enables the scheduling of specific activities and all interdependencies—with the added benefit of simulating forward many alternative plans and contingencies.

In accordance with another exemplary embodiment, the user interface module is configured to provide output for use in scheduling procedures and activities and will be referred to herein as “Provider/Patient Kiosk”. Provider/Patient Kiosk may be thought of as workflow, the kiosk is information gathering and output for the various stakeholders in the clinical process. It gathers information that is later used to reduce variation and it interacts with the stakeholders in mediums that are natural extensions of their native environments. The user interface may include computer display and/or reports.

It is to be appreciated that the user interface module may comprise one or more of the capabilities described above, as well as any combination thereof.

Endogenous variation is reduced within clinical process from situations arising from concurrent scheduled use of mutually exclusive resources such as doctors, nurses, equipment and space regardless of the cause being endogenously or exogenously perturbed. Methods according to the present invention move clinical process decisioning as far forward into the care process as possible. Known interdependencies are then brought to each decision point and factored in so that interdependencies are then managed and visible immediately, including well before blocks schedules are derived and patients are scheduled.

Embodiments of the present invention address the immediate, inevitable deviations from plan with diagnoses capability, in near real time, for the causality of endogenously generated variation and provides decision support for prospective process recovery to either the originally proscribed state or a new, superior one, given other operating constraints that render the original plan less advantageous. Exogenous variation—that which happens to the delivery system, despite the care and safety margin in the process scheduling, such as for example unanticipated medical complications, a surge of additional procedure(s) or an unanticipatable staffing change or equipment outage—is addressed by the ability to see the impact of change at or before it is currently possible to see it and then to provide feasible path forward decision support.

A key enabler of designing out preventable variation and to making allowances for residual normal variation is the time constant to detect change and make decisions. The decisioning time constant is enabled via the disclosed method and system to fall within the time constant of unrecoverable process oscillation.

Major sources of endogenous variation resulting from interdependencies amongst resources are the block allocation and detailed scheduling of resources such as, for an exemplary embodiment, the perioperative operating rooms, staff, materials, equipment and information; well understood and planed for procedure variation; day view and plan; staff understanding and buy-in to operations via advance case simulation and alternatively debriefing historic operating results in a day replay mode; and interactive/proactive routing of information and decisioning associated with the clinical process workflow into infrastructure utilized by the stake-holders.

The disclosed invention describes Duration Estimator, Block Allocation Planner, Day View, Day Planner/Day Replay and Provider/Patient Kiosk as elements of the information and decisioning inventions designed to reduce systemic variations by eliminating schedule risk up front and enabling rapid on-the-fly response to unanticipated perturbations to the clinical process.

It is most advantageous to not only know what is scheduled, but to know that what is scheduled is robust to unplanned events, to have an assessment of the schedule risk, to have the ability to visualize likely process scenarios before hand, to be able to determine robust decisions that can be taken in the dynamic environment that will best achieve the operating objectives, to learn from what transpired, to achieve departmental objectives and to include stakeholders in the clinical process. Each of these advantageous capabilities is advanced with the disclosed invention.

Referring to FIG. 2, an embodiment for a Duration Estimator module is shown. Clinical procedures have vast variation yet the advanced scheduling typically is made at a single prescribed duration time. When procedures take less than the forecast (typically estimated as the average for a procedure plus, perhaps, a safety margin), valuable assets are underutilized and clinical flexibility is degraded because the availability is unanticipated/unactionable and further, downstream processes are impacted from patient handling, staffing and equipment turn around. When procedures take more time than forecasted, valuable assets are unavailable for other procedures that were scheduled thus backing up upstream processes, creating staffing shortfalls and fatigue stress from the emotional responses to schedule collapse and recovery.

Estimating the duration of a procedure has a number of difficulties. One forecast difficulty is the variation on single procedure cases that results from doctor/staff combinations, patient disease state severity, patient medical complications and physical attributes such as weight/height/body mass index (BMI)/surface area, information availability, equipment and supply availability, day of week, procedure prior and etc. Another still is wrong or non-recorded information such as, for example, time durations, and multiple procedures conducted with only a subset being recorded as actually having been conducted.

The objective of understanding the variance in procedure duration is so that the schedules may be made more robust. How schedules are made robust will be discussed below with reference to a module referred to as Day Planner. It must be understood what the interactions of factors are on specific procedure combinations or alternatively, to classify combinations of factors into defined duration probability densities. Either the procedure is called in a schedule planning simulation or using the time density functions directly.

Referring further to FIG. 2, a method 20 for duration estimation is shown. Duration estimation is accomplished depending upon the information initially available, for example a history of procedures 24, and then a learning loop 23 is implemented that reduces the forecast error by incorporating additional information such as accurate case times and well measured descriptive attributes that serve as leading indicators. In an embodiment of duration estimation as shown in FIG. 2, a procedure is scheduled with average known time and variance at step 21 for a procedure, e.g. in the operating room (OR) at step 22. Additionally, the history 24, like attributes 25, and variation explained at steps 26 and 27 are then incorporated into forecasting and scheduling.

In the absence of a historical record, duration estimation is achieved via expert input (not shown separately but can be included in history 24). Experts include consensus of relevant professionals collated via industry working groups, societies and academic study, nursing, administrators, anesthesiologists and surgeons. Historical data of recorded procedures and their duration are more desirous than strictly expert opinion. A preliminary analytical step is to characterize the accuracy (mean and statistical variation) of historical procedure duration vs. actual for like cases. This is achieved with a design of experiments on a subset of procedure and/or procedure clustering and then compared to the historical record. Additionally, audits are conducted to compare scheduled vs. recorded as being conducted. Art from the methods of gauge repeatability and reliability are then used to characterize the confidence interval of forecasted duration. Regardless of the accuracy, a measure of duration classification is made and its degree of uncertainty is established.

FIG. 1 depicts the core concept of Duration Estimation. Earlier than anticipated finishes may afford additional schedule margin if only visibility existed either at the time of booking or once the procedure(s) began that a room would have capacity. Likewise, delays ascertainable at scheduling or during the procedure, if better understood, would impact the interdependencies downstream of the procedure both for that clustering of patient/staff/asset and for other impacted clusters. The schedule robustness is attained from planning the median, average and a notion of anticipated variation such as standard deviation. Within this window 10, indicated as a dotted line, and adjustable and/or tunable via stochastic optimization, the system level schedule is made to be robust (having a selectable and tunable probability expectation).

The history of procedures is combined into a relational database or spreadsheet or analytical platform capable of data mining with data incorporated into a data repository. The objective is to regress potential leading indicators against the historical duration times in an attempt to incorporate significant predictive variables that can then be used at the time of booking to allocate time.

Where it is possible to describe variation with enough confidence, then the regression equation is utilized plus a fraction of the variation to set the duration. In calculating what is ‘enough confidence’, a fraction of the variation is included in addition to the calculated duration using the regression equation.

Enough confidence is a function of the case throughput for a period, typically defined as a day given that there is a slack time off hours for schedule catch-ups to be made day to day. The cumulative probability density function for all cases in an allocated day is set to a level of schedule risk at a given time within the day. This would be expressed as a desire to be, for example, that the caseload can be processed by 7 PM with 90% confidence. A back propagation to the discrete cases is made such that the individual error terms (variation) are incorporated to the calculated duration in fractional steps until such time as the portfolio of cases can meet the daily throughput/risk setpoints. This may be performed manually or with the assistance of a stochastic optimization.

It can be the case that historical data is insufficient to separate between procedure(s) with statistical significance given the available leading indicators. In this instance, the histogram of all procedures can be partitioned and procedures that cannot be statistically separated may be clustered such that each is associated with a probability density function (PDF) of time duration. The total of the PDFs form the complete enumeration of the historical procedures less holdouts of known data defects

A learning loop 23 is established that finely records attributes and procedure times. As is the case when first classifying duration from the historical record, techniques including Artificial Neural Networks, Multivariate Regression, Analysis of Variance (ANOVA) and Correlation Analysis are used to refine predictive capability and tighten the confidence bounds. Additionally new descriptive attributes may be appended in order to test and improve forecast accuracy.

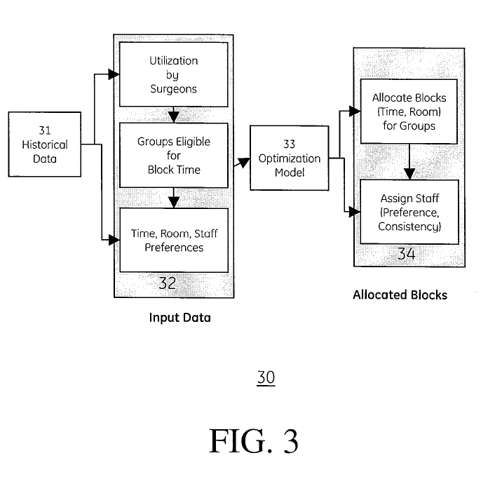

Referring now to FIG. 3, an embodiment for a Block Allocation Planner module 30 is shown. Healthcare stakeholders need a cadence to which schedules for room, staff, equipment and patients can be scheduled into in such a way that achieves the provider's mission and operating objectives. Procedures are booked into the available blocks. This process is well described in the literature with a number of commercial applications serving this function.

What does not exist is a method and system to allocate block time in such a way as to simultaneously satisfy stakeholder preferences. Additionally, there is a present need to have available in the market an engine to ‘re-sort’ block allocation from time to time in an institution. Similar to the need for a defragmenter utility for a computer hard drive—healthcare blocks are allocated based upon past, evolutionary activity. Staff, rooms, procedures, patient demographics, clinical specialties and competitors all drive changing assumptions of former time and space allocations.

It is to be appreciated that methods and systems described herein may enable increased throughput, schedule risk reduction, incentive driven policy, preferences and a consistent environment. Hospitals, surgeons, patients and staff are beneficiaries.

The method proceeds as depicted in FIG. 3 showing the Block Allocation module. At step 32, input data such as utilization by surgeons, groups eligible for block time and time, room and staff preferences are provided. As used herein, the term “block” refers to an allotted time frame such as for scheduling an operating room or clinical procedure room, e.g. imaging room. Historical block allocation data is characterized by the art of data mining to describe utilization by surgeon. Hospital administration determines the groups eligible for block time and preliminarily reconciles requests. The preferences are identified both by historical check and by communication to the stakeholders—between surgeons and nurses, surgeons and rooms, equipment and precedent/antecedent procedures, anesthesiologists and other logistical requests. Administration sets objectives such as the degree of concurrent satisfaction of the preferences, departmental goals such as throughput, case mix, doctor mix and departmental outcomes. A multi-criteria optimization is run at step 33. At step 34, staff is subsequently assigned to operating rooms.

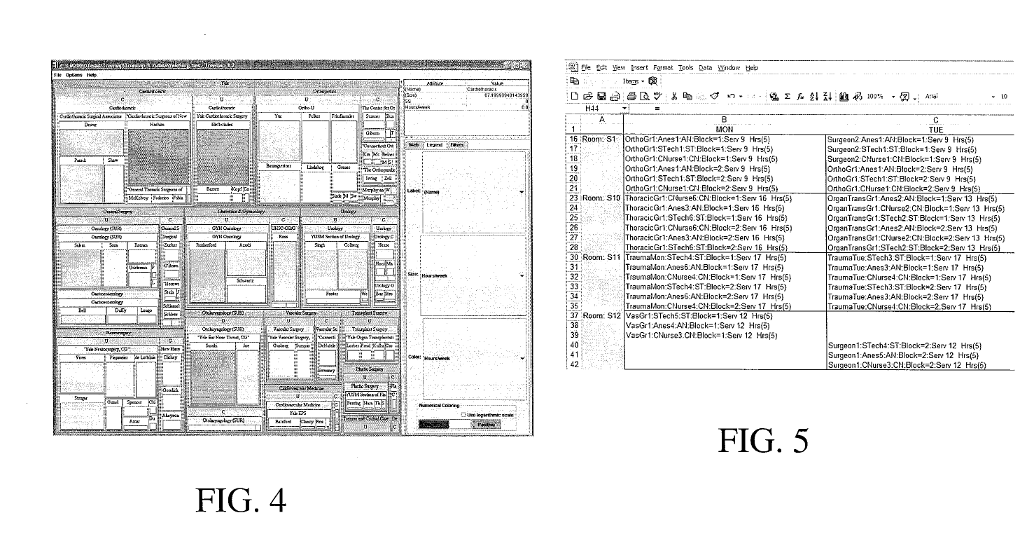

Objective decision-making is an explicit benefit of the disclosed system. Having the ability to communicate visually is key to rapid understanding. A ‘cockpit’ describing the historical fact patterns and current operating results is key to facilitating conversation. The use of cockpits has been described in other known business systems. A further extension is depicted in FIG. 4.

The block schedule output may take many forms. An example embodiment is FIG. 5.

In embodiments of the present invention, a user interface module may be provided in order to get information to a user for use in scheduling procedures. In an exemplary embodiment, user interface comprise the ability to monitor activities for a given day, and will be referred herein as “Day View”. Day View may be thought of as being a radar for the perioperative environment coupled to a logic engine. More that simply alarming a problem, Day View prospectively assesses interdependencies such as, for example, a certain procedure and a piece of equipment and staff required for the procedure. Should the location and availability not be per the schedule, an alarm is first made as a warning for action. If as the time of need approaches, the interdependent items are located via passive and active identification. If the issue can be resolved such as via a phone call or quick action—an issue was avoided or minimized.

Should the interdependency not be solved, Day View has the capability to simultaneously solve for all other interdependencies and allow a ‘what-if’ scenario testing exercise to occur. The what-if may be manual or automatic.

By having a procedure finish before the schedule, potential scheduling flexibility is lost for other issues that inevitably arise during the day such as staff availability, rooms and equipment constraints. Potential throughput capacity might also be impacted in that over the course of a day, one or more additional procedures could be inserted into the schedule.

A longer than anticipated procedure can have the effect of backing up other dependent procedures for a particular patient either in the original department or cross departmentally. Additionally, the rooms and assets that were originally allocated are no longer as available and therefore other patients and activities are negatively impacted. There may be unscheduled overtime of staff or extra costs associated with turning around apparatus. New schedules must be made that impacts reworking of staff planning as well as the potential for rework on case preparation for following or interdependent procedures. The anticipated and/or needed throughput capacity may also be impacted negatively. These changes reduce operating flexibility and increase the anxiety of the clinical process stakeholders—often leading to what is commonly known as ‘burn-out’ and attrition, as well as to the potential ultimate quality of delivered healthcare.

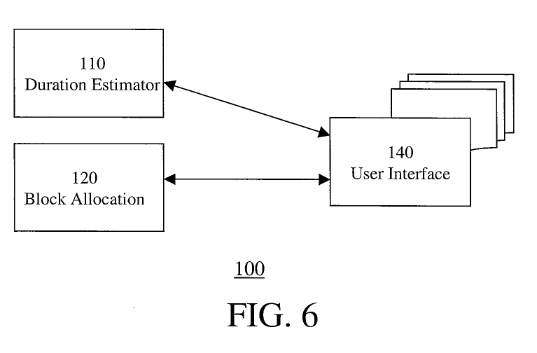

Referring now to FIG. 6, a block diagram illustration of a system for use in planning clinical procedures in accordance with embodiments of the present invention. System 100 includes a duration estimator module 110, block allocation planner module 120 and user interface 130 as described in detail above. While embodiments have been described with reference to a clinical setting, it is to be appreciated that other environments may also benefit from similar methods and modules described herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for use in planning procedures subject to variation, the system comprising:
a duration estimator module configured to characterize average duration times and variations from average duration times for a given procedure or activity;
a block allocation planner module configured to schedule the procedure or activity in accordance with characterized times from the duration estimator module; and,
a user interface module configured to permit a user to visualize variation, to visualize scheduling opportunities and constraints and to view information for use in scheduling procedures and activities.

2. The system of claim 1 wherein the given procedure is at least one of a clinical procedure or activity.

3. The system of claim 1 the user interface is configured to simulate process decisions prior to scheduling the given procedure or activity

4. The system of claim 1 wherein the block allocation planner is further configured to permit for planning and allocating at least one of time slots, facilities and equipment for the given procedure based on availability.

5. The system of claim 1 wherein the user interface comprises at least one of computer display and reports.

6. A method for planning procedures subject to variation, the method comprising:
deriving duration times for a given procedure;
updating duration times for the given proceudre as variation is detected; and,
using updated duration times for forecasting and scheduling subsequent procedures.

7. The method of claim 6 wherein the given procedure is at least one of a clinical procedure or activity.

8. The method of claim 6 further comprising the step of:
planning and allocating at least one of time slots, facilities and equipment for the given procedure based on availability.

9. The method of claim 6 further comprising providing a user interface configured to perform at least one of user visualizing variation, user visualizing scheduling opportunities and constraints, and providing user information for use in scheduling procedures and activities.

10. The method of claim 9 wherein the user interface is configured to simulate process decisions prior to scheduling the given procedure or activity.

11. The method of claim 9 wherein the user interface comprises at least one of display and reports.

12. A system for use in planning clinical procedures subject to variation, the system comprising:
a duration estimator module configured to characterize average duration times and variations from average duration times for a given clinical procedure or activity;
a block allocation planner module configured to schedule clinical procedures or activities in accordance with characterized times from the duration estimator module; and,
a user interface module configured to permit a user to visualize variation, to visualize scheduling opportunities and constraints and to view information output for use in scheduling clinical procedures and activities.

13. The system of claim 12 wherein the duration time estimated for the given clinical procedure is characterized for preferences of respective staff and equipment.

14. The system of claim 13 wherein the block allocation planner is further configured to permit for planning and allocating at least one of time slots, facilities and equipment for the given clinical procedure based on availability and duration time estimated for the clinical procedure.

15. The system of claim 12 wherein the user interface comprises at least one of computer display and reports.
